(19) United States
(12) Patent Application Publication
(10) Pub. No.: US 2003/0001351 A1
(43) Pub. Date: Jan. 2, 2003

(54) Apparatus and method for stowing, for securing for travel, and for transporting omnium-gatherum personal effects

(76) Inventors: Gregory D. Schauble, Phoenix, AZ (US); Lori A. Young, Phoenix, AZ (US)

Correspondence Address: Tod R. Nissle, Esq., TOD R. NISSLE, P.C., P.O. Box 55630, Phoenix, AZ, 85078, US

(21) Appl. No.: 09/893,821

(22) Filed: Jun. 28, 2001

(51) Int. Cl. B62M 1/00

(52) U.S. Cl. 280/87.05; 280/87.041

(57) ABSTRACT

A scooter is provided for stowing, securing, and transporting omnium-gatherum. The scooter includes a telescoping handle attached to a base or platform that a user stands on during use of the scooter. The handle is pivoted between a deployed operative position so the user can stand on the platform and used the handle and a stowed operative position with the handle folded to a position adjacent the platform. A pliable storable container is attached to the handle such that the container remains on the handle while the handle is telescopically adjusted and while the handle is folded into position adjacent the platform. A portion of the pliable storage container slides along the handle when the handle is telescopically adjusted.

This invention relates to apparatus for stowing, securing, or transporting omnium-gatherum.

More particularly, the invention relates to a scooter apparatus for stowing, securing, or transporting omnium-gatherum.

Automobiles, motorcycles, and bicycles have long utilized baskets and other containers for carrying and transporting personal effects. Scooters, however, have apparently not included such containers. A scooter includes a horizontally oriented platform and includes an upstanding handle which is mounted on and extends upwardly from the front of the platform. One ground engaging wheel, the back wheel, is attached to the back of the platform. A second gound engaging wheel, the front wheel, is mounted at the front of the platform on the bottom of the handle. When a user turns or rotates the handle, the front wheel turns simultaneously with the handle.

In one well known type of scooter, sometimes called a “RAZOR” scooter after the RAZOR trademark found on some such scooters, the handle includes a telescoping shaft. The upper end of the shaft includes a pair of grips (one for each hand), typically spaced only three to four inches apart. The lower end of the telescoping shaft is pivotally attached to the platform so that after the shaft is telescoped together to reduce the length of the shaft, the shaft can be folded against the platform to compact the scooter for travel. Mounting a basket or other container on this type of scooter is believed impractical because the basket cannot be mounted on the grips, because there is not sufficient spaced on the handle, and because the handle is folded telescopically and pivotally—which means the basket would have to be removed before the handle was telescopically reduced in length and folded. Another disadvantage of attempting to mount a basket on a scooter is that the front wheel of the scooter is small and has a diameter in the range of three to five inches, typically only about three and a half inches to four inches. A conventional basket or other container would usually extend outwardly from the handle past this wheel, making the scooter unstable.

Although containers are apparently not utilized on scooters for the foregoing reasons and other reasons, there are many scooters in use. Accordingly, it would be highly desirable to provide an apparatus and method for carrying, simple and safely, personal effects on scooters.

Therefore, it is a principal object of the instant invention to provide an improved method and apparatus for stowing and for transporting omnium-gatherum.

A further object of the invention is to provide an improved apparatus for stowing and transporting omnium-gatherum on a scooter of the type including a telescoping, folding handle which turns simultaneously with a wheel mounted on the handle and including closely spaced grips on the handle.

These and other, further and more specific objects and advantages of the invention will be apparent to those skilled in the art from the following detailed description thereof, taken in conjunction with the drawings, in which:

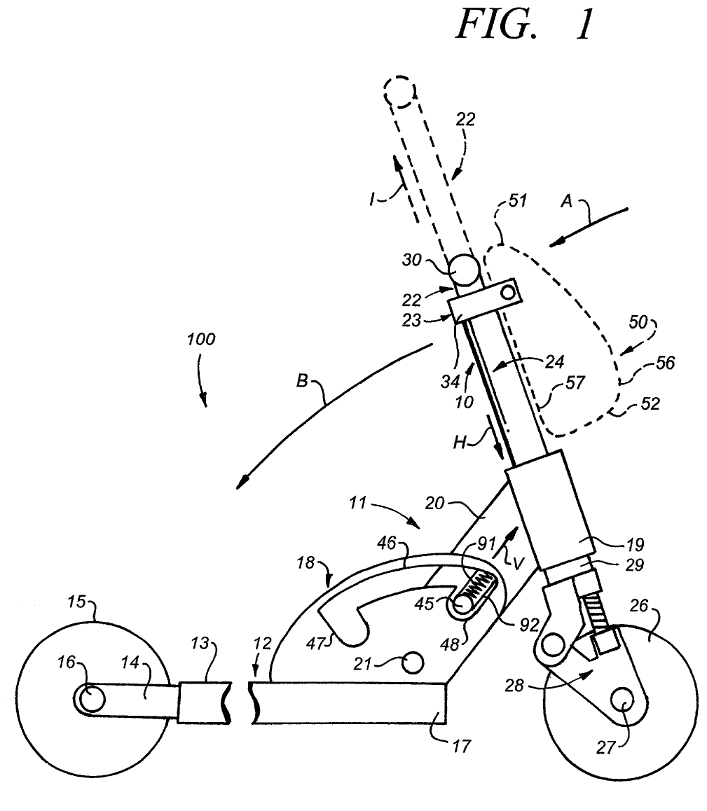

FIG. 1 is a side elevation view illustrating a scooter apparatus constructed in accordance with the principles of the invention;

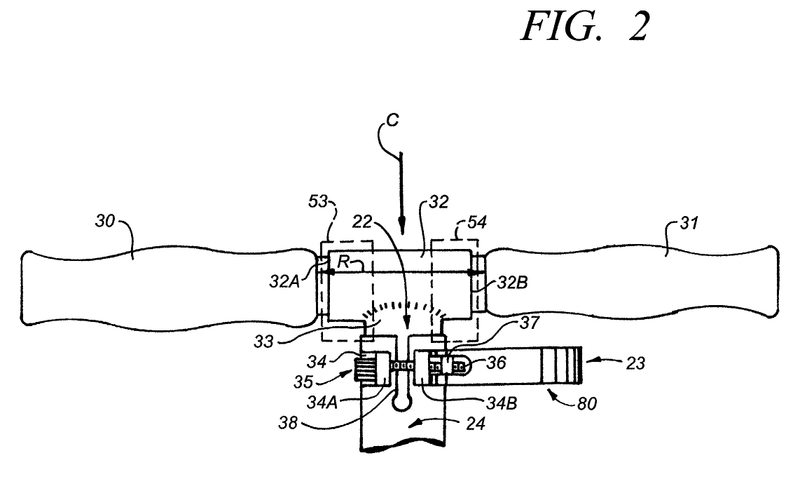

FIG. 2 is a front view of the scooter of FIG. 1 from the perspective of arrow A and further illustrating the upper portion of the handle body of the scooter of FIG. 1 and construction features thereof;

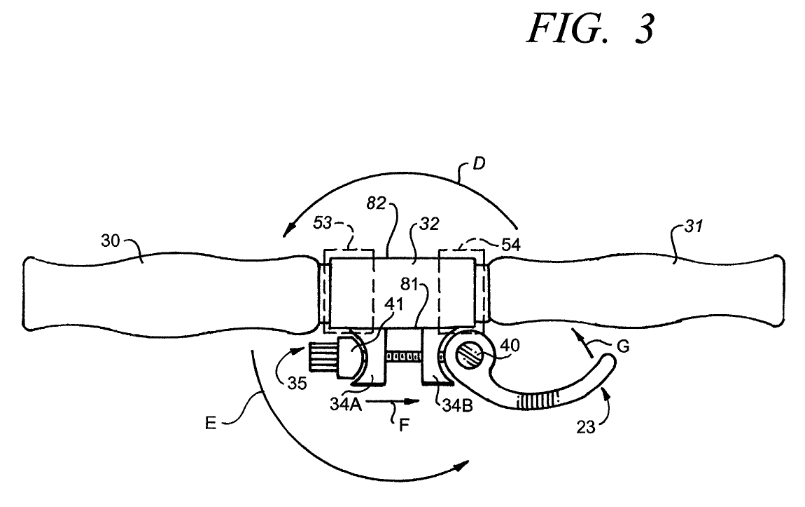

FIG. 3 is a top view of the upper portion of the handle body of FIG. 2 further illustrating construction details thereof;

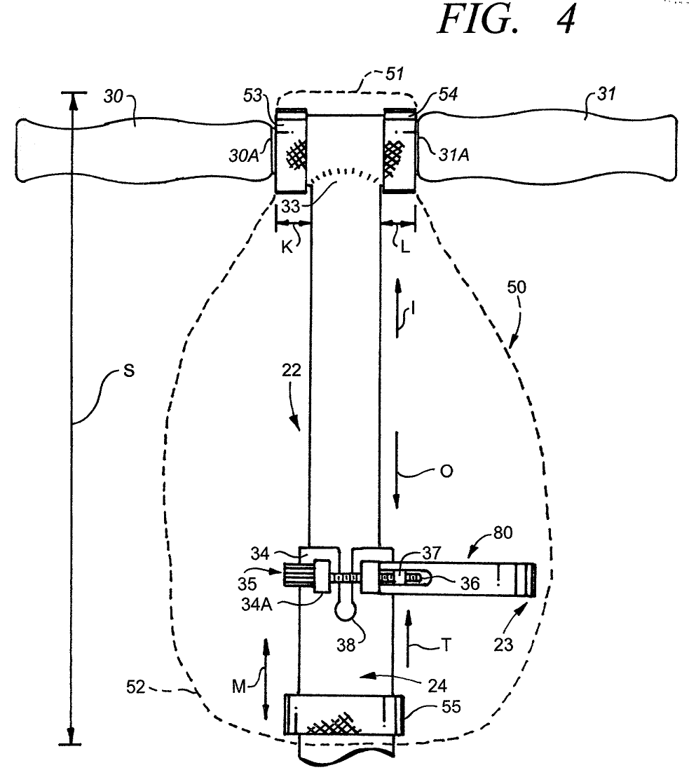

FIG. 4 is a front view of the scooter of FIG. 1 from the perspective of arrow A and further illustrating the upper portion of the handle body after the top member of the body has been telescopically extended from the lower member of the body; and,

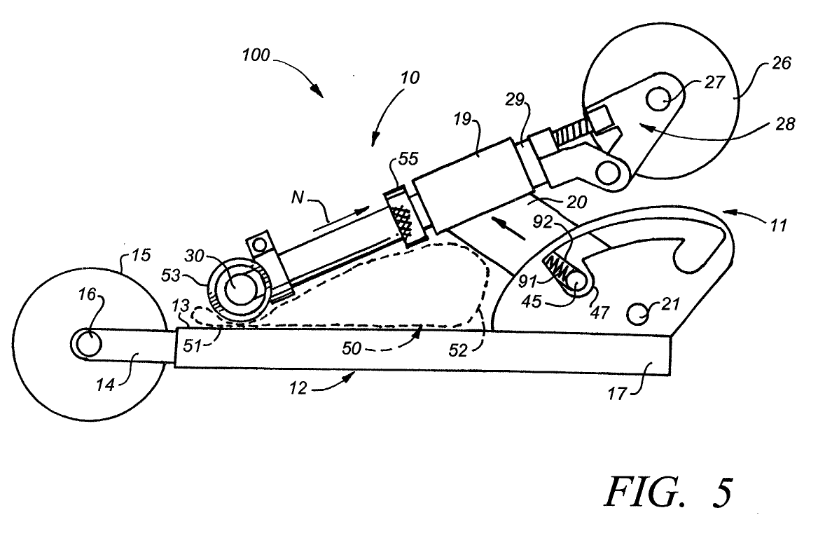

FIG. 5 is a side elevation view of the scooter of FIG. 1 illustrating the handle body in a folded configuration.

Briefly, in accordance with the invention, I provide an improved scooter apparatus for stowing, securing for travel, and transporting omnium-gatherum. The apparatus includes a platform for a user to stand on. The platform has a front and a rear. The apparatus also includes a ground engaging wheel mounted on the rear of the platform, and a stowable steering—handle assembly connected to the front of the platform. The stowable steering—handle assembly includes an elongate body including a elongate first and second members slidably telescopically interconnected such that the first member can be moved between at least two operative positions, a first operative position with the first member in a storage position which shortens the body, and a second operative position with the first member telescopically extended from the first member to increase the length of the body such that the body can be utilized as support by a user standing on the base. The first member includes a distal end and the second member includes a distal end. The stowable steering—handle assembly also includes a ground engaging wheel mounted on the distal end of the second member, and includes a handlebar mounted on the distal end of the first member. The handlebar includes a neck attached to the distal end of the first member and includes a pair of outer ends each extending outwardly a short distance from the first member. A pair of handles are each mounted on and extend outwardly from a different one of the distal ends of the neck. The steering—handle assembly also includes apparatus connected to the front of the platform for moving pivotally the body between at least a pair of operative positions. One of the operative positions is a deployed operative position such that a user can stand on the platform, grasp the handles, and use the body for support. The other operative position is a stowed operative position with the first member in the first operative position and said body pivotally moved from the deployed operative position to the stowed operative position and folded toward the platform. The apparatus also includes a pliable deformable container for storing omnium-gatherum. The container includes a front, back, top, and bottom, includes first fastening apparatus attached to the top of the container to secure the container to at least one of the outer ends of the neck, and includes a second fastening apparatus attached to the container to secure slidably the container to the second member of the body such that when the first member is moved from the first to the second operative position, the second fastening apparatus slidably moves along the second member.

In accordance with another embodiment of the invention, I provide an improved scooter apparatus for stowing, securing for travel, and transporting omnium-gatherum. The apparatus includes a platform for a user to stand on. The platform has a front and a rear. The apparatus also includes a ground engaging wheel mounted on the rear of the platform, and a stowable steering—handle assembly connected to the front of the platform. The stowable steering—handle assembly includes an elongate body including a elongate first and second members slidably telescopically interconnected such that the first member can be moved between at least two operative positions, a first operative position with the first member in a storage position which shortens the body, and a second operative position with the first member telescopically extended from the first member to increase the length of the body such that the body can be utilized as support by a user standing on the base. The first member includes a distal end and the second member includes a distal end. The stowable steering—handle assembly also includes a ground engaging wheel mounted on the distal end of the second member, and includes a handlebar mounted on the distal end of the first member. The handlebar includes a neck attached to the distal end of the first member and includes a pair of outer ends each extending outwardly a short distance from the first member. A pair of handles are each mounted on and extend outwardly from a different one of the distal ends of the neck. The steering—handle assembly also includes apparatus connected to the front of the platform for moving pivotally the body between at least a pair of operative positions. One of the operative positions is a deployed operative position such that a user can stand on the platform, grasp the handles, and use the body for support. The other operative position is a stowed operative position with the first member in the first operative position and said body pivotally moved from the deployed operative position to the stowed operative position and folded toward the platform. The apparatus also includes a pliable deformable container for storing omnium-gatherum. The container includes a front, back, top, and bottom, includes first fastening apparatus attached to the top of the container to secure the container to at least one of the outer ends of the neck, and includes second fastening means attached to the container to secure slidably the container to the body. The container is shaped and dimensioned such that when the body is moved to the stowed position, the container is compressed between the body and the platform.

In accordance with a further embodiment of the invention, I provide an improved scooter apparatus for stowing, securing for travel, and transporting omnium-gatherum. The apparatus includes a platform for a user to stand on. The platform has a front and a rear. The apparatus also includes a ground engaging wheel mounted on the rear of the platform, and a stowable steering—handle assembly connected to the front of the platform. The stowable steering—handle assembly includes an elongate body including a elongate first and second members slidably telescopically interconnected such that the first member can be moved between at least two operative positions, a first operative position with the first member in a storage position which shortens the body, and a second operative position with the first member telescopically extended from the first member to increase the length of the body such that the body can be utilized as support by a user standing on the base. The first member includes a distal end and the second member includes a distal end. The stowable steering—handle assembly also includes a ground engaging wheel mounted on the distal end of the second member, and includes a handlebar mounted on the distal end of the first member. The handlebar includes a neck attached to the distal end of the first member and includes a pair of outer ends each extending outwardly a short distance from the first member. A pair of handles are each mounted on and extend outwardly from a different one of the distal ends of the neck. The steering—handle assembly also includes control apparatus connected to the front of the platform for moving pivotally the body between at least a pair of operative positions. One of the operative positions is a deployed operative position such that a user can stand on the platform, grasp the handles, and use the body for support. The other operative position is a stowed operative position with the first member in the first operative position and said body pivotally moved from the deployed operative position to the stowed operative position and folded toward the platform. The control apparatus also permits the body to rotate between at least a pair of operative positions, a forward operative position with the front of the body facing outwardly away from the platform, and a rearward operative position with the body rotated 180 degrees from the forward operative position such that the front of the body faces the platform. The apparatus also includes a pliable deformable container for storing for storing omnium-gatherum and including a front, back, top, and bottom, includes first fastening apparatus attached to the top of the container to secure the container to at least one of said outer ends of the neck, and includes second fastening apparatus attached to the container to secure slidably the container to the body. The container is shaped and dimensioned such that when the container is on the front of the body and the body is in the rearward position and is moved to the stowed position, the container is compressed between the body and the platform.

In still another embodiment of the invention, I provide an improved method of storing, of securing for travel, and for transporting omnium-gatherum, including the steps of providing the apparatus of claim 1; placing the body in the deployed position; telescopically extending the first member to the first operative position; placing omnium-gatherum in the container; using the apparatus such that the wheels roll over the ground a selected distance; placing the first member in the second operative position; folding the body to the stowed operative position; carrying the apparatus a selected distance; and, removing at least some of the omnium-gatherum from the container.

Turning now to the drawings, which illustrate the presently preferred embodiments of the invention for the purpose of illustrating the practice thereof, and not by way of limitation of the scope of the invention, and in which like reference characters refer to corresponding elements throughout the several views, FIG. 1 illustrates scooter apparatus 100 constructed in accordance with the invention and including a platform 12, steering—handle assembly 10, and support apparatus 11 for pivotally foldably stowing the steering—handle assembly.

Support apparatus 11 includes hollow cylindrical collar 19, connecting member 20, and flange 18. Flange 18 is fixedly connected to the top of platform 12. Cylindrical pin 45 is spring-loaded and is mounted in groove 92 of member 20. Pin 45 extends outwardly into and seats in the bottom of notch 48 in the manner shown in FIG. 1, but can be displaced in the direction of arrow V in groove 92 to compress spring 91. Displacing pin 45 in the direction of arrow V moves pin 45 out of notch 48 so pin 45 can slide along groove 46 and seat in notch 47 when handle—steering assembly is being folded into the configuration shown in FIG. 5. Pin 45 can be manually displaced to compress spring 91 in the direction of arrow V. Arcuate slot 46 extends through upstanding flange 18 and interconnects notches or apertures 47, 48 formed through flange 18 along with slot 46. Pin 21 is fixedly secured to flange 21 and extends into member 20 such that member 20 can pivot about pin 21.

Platform 12 includes upper surface 13, front end 17, and rear end 13. Member 14 is fixedly connected to and extends outwardly from end 13. Ground engaging wheel 15 is rotatably mounted on pin 16. Pin 16 is fixedly mounted on member 14.

Steering—handle assembly 10 including an elongate body which includes elongate cylindrical first member 22 and elongate hollow cylindrical second member 24. Member 22 is telescopically mounted in member 24 and slides into and out of member 24 between at least first and second operative positions. The first operative storage position is shown in FIGS. 1, 3, and 5, where member 22 is slid into member 24. The second operative deployed position is shown in FIG. 4 where member 22 is slid out of member 24 in the direction of arrow I. A notch 38 is formed in the top of member 24. A clamp assembly 80 compresses the top of member 24 against telescoping member 22 to maintain member 22 in a desired position.

The clamp assembly 80 includes collar 34. Collar 34 includes depending outwardly projecting flanges 34A and 34B. Apertures are formed through flanges 34A and 34B such that the threaded portion 36 of bolt 35 can extend through the apertures in the manner shown in FIG. 4. The threaded end of portion 36 threads into an internally threaded aperture (not visible) formed through pin 37. The ends of pin 37 extend through apertures (not visible) formed through latch member 23. When latch member 23 is in the open position shown in FIG. 4, member 22 can freely slide up and down in hollow member 24. When latch member 23 is displaced in the direction of arrow G in FIG. 3, flanges 34A and 34B are pressed together, and notch 38 is squeezed and reduced in size to reduce the inside diameter of the top of member 24 and, consequently, to squeeze the inner surface of the top of member 24 against member 22 to maintain member 22 in a desired position. Any other desired fastening means can be utilized in place of the clamp assembly 80 in order to maintain telescoping member 22 in a desired position with respect to member 24.

The distance K from the inner end of grip or handle 30 to member 22 is in the range of 0.5 inch to 2.0 inches, and typically is about one inch. The distance L from the inner end of grip or handle 31 to member 22 is in the range of 0.5 inch to 2.0 inches, and typically is about one inch.

Neck 32 includes ends 32A and 32B. The front 81 of neck 32 is the front of steering handle—assembly 10. The back 82 of neck 32 is the back of steering handle—assembly 10.

One inch wide detachable pliable bendable strip 53 is attached around end 32A between grip 30 and member 22. One inch wide detachable pliable bendable strip 54 is attached around end 32B between grip 31 and end member 22. One inch wide detachable pliable bendable strip 55 is attached around member 24 beneath the clamp assembly 80 in FIG. 4. Strip 55 can slide along member 22 in the directions indicated by arrows M. Strips 53 to 55 can be made using Velcro, can be made using clips or buckles, or can be made with any other desired detachable or non-detachable fastening means which can be secured around ends 32A and 32B and member 24.

Pliable container 50 is attached to strips 53 to 55 with thread, adhesive, or other desired fasteners. Container 50 is preferably made from a fabric or other pliable, bendable material such that when the apparatus of the invention is folded in the manner shown in FIG. 5, the container 50 can be at least partially compressed between steering handle assembly 10 and platform 12. The container includes a top 51, a bottom 52, front 56, and back 57. Top 51 is attached to strips or straps 53 and 54. Bottom 52 is attached to strip or strap 55. Container 50 can include pockets, flaps, a top, compartments, etc. Top 51 must be narrow enough to fit between the inner ends 30A and 31A of grips 30 and 31. The distance R between ends 30A and 31A is in the range of two to four inches, and is typically about three inches. The length S (FIG. 4) of container 50 must be sufficient so that when member 22 is in the extended position shown in FIG. 4, strip 55 is on member 24. In other words, in FIG. 4, container 50 must extend from neck 32 to the top of member 24. It is important that container 50 extend from neck 32 to the top of member 24 because otherwise strip 55 ordinarily must be fastened about the lower part of member 22, which means that before member 22 can be telescopically collapsed to the position shown in FIG. 1, strip 55 must be removed from member 22 to avoid damaging container 50 when clamp assembly 80 is opened and member 22 is slid in the direction of arrow O to the position shown in FIGS. 1 and 2.

As indicated by arrows D and E in FIG. 3, the member 24 can be rotated in hollow collar 19 three hundred and sixty degrees from the position shown in FIG. 1. When member 24 is rotated, member 22, wheel 26, and each of the other components of the steering—handle assembly 10 rotate simultaneously with member 24. In FIG. 5, the steering handle assembly 10 has been rotated one hundred and eighty degrees from the position shown in FIG. 1.

In use, container 50 is mounted on steering—handle assembly 10 in the position shown in FIG. 1 by attaching strips 53 to 55 to neck 32 and member 24, as the case may be, in the positions shown in FIG. 4. Latch member 23 is opened to the position shown in FIG. 3, and member 22 is slidably telescopically extended from member 24 in the direction of arrow I to the position shown by dashed lines 22 in FIG. 1 and shown in FIG. 4. When member 22 is extended in the direction of arrow I, strip 55 slides up member 24 in the direction of arrow T to the position shown in FIG. 4. Once member 22 is extended to the position shown in FIG. 4, latch member 23 is displaced in the direction of arrow G to close assembly 80 and secure member 22 in the position shown in FIG. 4. The user puts one of his feet on platform 12, grasps grips 30 and 31 with his hands, and pushes the scooter apparatus 100 in a conventional manner with his or her other foot to travel a selected distance. The user then steps off apparatus 100, opens latch 23 to the position shown in FIG. 3, telescopically moves member 22 in the direction of arrow O to the position sown in FIG. 2, and displaces member 23 in the direction of arrow G to close assembly 80 to secure member 22 in position. The user rotates the handle—steering assembly from the position shown in FIG. 1 in the direction of arrows D and E through an arc of one hundred and eighty degrees so that the front 81 of handle—steering assembly 10 is facing platform 12. The user manually displaces pin 45 in the direction of arrow V to compress spring 91. The user then pushes handle—steering assembly 10 in the direction of arrow B to slide pin 45 along notch 46 and fold assembly 10 into the position shown in FIG. 1. When assembly 10 is in the position shown in FIG. 1, container 50 is at least partially compressed between handle—steering assembly 10 and platform 12. In addition, when the handle—steering assembly 10 is moved to the position shown in FIG. 5, spring 92 expands and causes pin 45 to seat in notch 47. The user then picks up and carries apparatus a selected distance in its folded configuration, after which the user can remove container 50 from apparatus 100 or can remove all or a portion of the omnium-gatherum from container 50.

Having described the invention in such terms as to enable those of skilled in the art to understand and practice the invention, and having described the presently preferred embodiments thereof, I claim:

1. A scooter apparatus for stowing, securing for travel, and transporting omnium-gatherum, the apparatus including
(a) a platform for a user to stand on, said platform having a front and a rear;
(b) a ground engaging wheel mounted on said rear of said platform;
(c) a stowable steering—handle assembly connected to said front of said platform and including
(i) an elongate body including a elongate first and second members slidably telescopically interconnected such that said first member can be moving between at least two operative positions,
a first operative position with said first member in a storage position which shortens said body, and
a second operative position with said first member telescopically extended from said first member to increase the length of said body such that said body can be utilized as support by a user standing on said base,
said first member including a distal end and said second member including a distal end,
(ii) a ground engaging wheel mounted on said distal end of said second member,
(iii) a handlebar mounted on said distal end of said first member and including
a neck attached to said distal end of said first member and including
a pair of outer ends each extending outwardly a short distance from said first member,
a pair of handles each mounted on and extending outwardly from a different one of said distal ends of said neck, and
(iv) means connected to said front of said platform for moving pivotally said body between at least a pair of operative positions,
a deployed operative position such that a user can stand on said platform, grasp said handles, and use said body for support, and
a stowed operative position with said first member in said first operative position and said body pivotally moved from said deployed operative position to said stowed operative position and folded toward said platform;
(d) a pliable deformable container for storing omnium-gatherum and including a front, back, top, and bottom and
(i) first fastening means attached to said top of said container to secure said container to at least one of said outer ends of said neck, and
(ii) second fastening means attached to said container to secure slidably said container to said second member of said body such that when said first member is moved from said first to said second operative position, said second fastening means slidably moves along said second member.

2. A scooter apparatus for stowing, securing for travel, and transporting omnium-gatherum, the apparatus including
(a) a platform for a user to stand on, said platform having a front and a rear;
(b) a ground engaging wheel mounted on said rear of said platform;
(c) a stowable steering—handle assembly connected to said front of said platform and including
(i) an elongate body including a elongate first and second members slidably telescopically interconnected such that said first member can be moving between at least two operative positions,
a first operative position with said first member in a storage position which shortens said body, and
a second operative position with said first member telescopically extended from said first member to increase the length of said body such that said body can be utilized as support by a user standing on said base,
said first member including a distal end and said second member including a distal end,
(ii) a ground engaging wheel mounted on said distal end of said second member,
(iii) a handlebar mounted on said distal end of said first member and including
a neck attached to said distal end of said first member and including
a pair of outer ends each extending outwardly a short distance from said first member,
a pair of handles each mounted on and extending outwardly from a different one of said distal ends of said neck, and
(iv) means connected to said front of said platform for moving pivotally said body between at least a pair of operative positions,
a deployed operative position such that a user can stand on said platform, grasp said handles, and use said body for support, and
a stowed operative position with said first member in said first operative position and said body pivotally moved from said deployed operative position to said stowed operative position and folded toward said platform;
(d) a pliable deformable container for storing omnium-gatherum and including a front, back, top, and bottom and
(i) first fastening means attached to said top of said container to secure said container to at least one of said outer ends of said neck, and
(ii) second fastening means attached to said container to secure slidably said container to said body,
said container being shaped and dimensioned such that when said body is moved to said stowed position, said container is compressed between said body and said platform.

3. A scooter apparatus for stowing, securing for travel, and transporting omnium-gatherum, the apparatus including
(a) a platform for a user to stand on, said platform having a front and a rear;
(b) a ground engaging wheel mounted on said rear of said platform;
(c) a stowable steering—handle assembly connected to said front of said platform and including
(i) an elongate body having a front and a back and including a elongate first and second members slidably telescopically interconnected such that said first member can be moving between at least two operative positions,
a first operative position with said first member in a storage position which shortens said body, and
a second operative position with said first member telescopically extended from said first member to increase the length of said body such that said body can be utilized as support by a user standing on said base,
said first member including a distal end and said second member including a distal end,
(ii) a ground engaging wheel mounted on said distal end of said second member,
(iii) a handlebar mounted on said distal end of said first member and including
a neck attached to said distal end of said first member and including
a pair of outer ends each extending outwardly a short distance from said first member,
a pair of handles each mounted on and extending outwardly from a different one of said distal ends of said neck, and
(iv) means connected to said front of said platform
to permit so body to rotate between at least a pair of operative positions,
a forward operative position with said front of said body facing outwardly away from said platform, and
a rearward operative position with said body rotated 180 degrees from said forward operative position such that said front of said body faces said platform, and
for moving pivotally said body between at least a pair of operative positions,
a deployed operative position such that a user can stand on said platform, grasp said handles, and use said body for support, and
a stowed operative position with said first member in said first operative position and said body pivotally moved from said deployed operative position to said stowed operative position and folded toward said platform; and,
(d) a pliable deformable container for storing omnium-gatherum and including a front, back, top, and bottom and
(i) first fastening means attached to said top of said container to secure said container to at least one of said outer ends of said neck, and
(ii) second fastening means attached to said container to secure slidably said container to said body,
said container being shaped and dimension such that when said container is on said front of said body and said body is in said rearward position and is moved to said stowed position, said container is compressed between said body and said platform.

4. A method of storing, of securing for travel, and for transporting omnium-gatherum, including the steps of
(a) providing the apparatus of claim 1;
(b) placing said body in said deployed position;
(c) telescopically extending said first member to said first operative position;
(d) placing omnium-gatherum in said container;
(e) using said apparatus such that said wheels roll over the ground a selected distance;
(f) placing said first member in said second operative position;
(g) folding said body to said stowed operative position;
(h) carrying said apparatus a selected distance; and,
(i) removing at least some of said omnium-gatherum from said container.
